(19) United States
(12) Patent Application Publication
(10) Pub. No.: US 2005/0044848 A1
(43) Pub. Date: Mar. 3, 2005

(54) Compressed air pressure driven tooth brush, toy, shaver, drill, grinder, screw, driver, engraver, sander

(76) Inventor: Zoltan Egeresi, Santa Cruz, CA (US)

Correspondence Address: ZOLTAN EGERESI, 5500 COAST RD., SANTA CRUZ, CA, 95060, US

(21) Appl. No.: 10/934,542

(22) Filed: Sep. 2, 2004

Related U.S. Application Data
(63) Continuation-in-part of application No. 10/238,364, filed on Sep. 10, 2002.

(51) Int. Cl. F16D 31/02

(52) U.S. Cl. 60/413

(57) ABSTRACT

This oral cleansing device assembly is an oral hygiene tool, which is powered by compressed air pressure. My invention uses no electricity, no battery; brush-driving power is derived from a small air motor with a rechargeable small compressed air tank integrated into the handle. This invention provides lifetime functionality to a power driven dental brush since compressed air is replaceable, reusable resource. Air compressor cradle is used to recharge the small tank. The same system can be used to replace rechargeable or alkaline batteries (with limited life cycle) to power electric tooth brushes, electric razor, toy cars and many small tools cordless drills, sanders where short duration cordless use is desired. Over the life time of the product by not replacing batteries, this system is more economical, also cost of design can be reduced.

### FIELD OF THE INVENTION

The present application relates to mobile, cordless power source, replacing rechargeable or alkaline batteries of a electric tooth brush, electric razor, toy cars, cordless drill, engraver, sander and other small tools where short time power is required repeatedly.

The present application further relates to such a devices as small grinder, where mobile, life time, throw away batteries are polluting expensive. My invention uses renewable air in compressed form as a power source. Recharging air tanks are measured in seconds versus batteries where hours are needed. This invention shows an “electric” toothbrush Shaver, Toy car, Screw Driver, Grinder, and an Engraver powered by compressed air, air motor with a detachable brush assembly.

### BACKGROUND OF THE INVENTION

Most Electric toothbrushes are rechargeable, battery and electronics are sealed in a watertight enclosure. Rechargeable batteries have a limited lifetime, therefore when the battery becomes unusable the whole unit needs to be replaced at considerable expense. In-home used electric razors can be powered by compressed air and air can also be used to clean out, blow out the shaved off hair. Most cordless tools with rechargeable batteries could use compressed air as a power source to save considerable amount of money by not requiring frequent batteries replacement.

Recharging time takes seconds and not hours. Air is in-exhaustible renewable resource.

### PRIOR ARTS

References in U.S. patent Documents

References in U.S. Patent Documents

| | |
|---|---|
| 3,509,847 | 05-1970 Stillman Theodore |
| 3,502,072 | 03-1970 Stillman Theodore |
| 4,928,675 | 05-1990 Thornton |
| 3,273,189 | 09-1966 Levinson Luis |
| 5,974,613 | 11,l999 Herzog, Karl |
| 4,337,040 | 06-1982 Cammack |
| 4,698,869 | 10-1987 Mierau |
| 4,989,590 | 02-1991 Baum |
| 5,416,942 | 05-1995 Baldacci |
| 5,448,792 | 09-1995 Wiedemann |
| 5,697,117 | 12-1997 Craft, Adam |
| 5,421,726 | 06-1995 Okada |
| 5,165,131 | 11-1992 Staar, Marcel |
| 4,302,186 | 11-1981 Cammack |
| 4,229,634 | 10-1980 Hickman |
| 5,954,141 | 9-21-199 Li et al. |
| 6,501,197 | 12-2002 Cornog et al. |
| 6,079,954 | 5-2000 Kownacki et al. |

### FOREIGN PATENT DOCUMENTS

39 37 850 11/199 Germany, 42 39 251 May 1994 Germany, 09300812 November 1993 Belgium

### FIELD OF SEARCH

15/22.1; 15/28; 15/29; 173/93; 307/150; 417/63; 469;

### BRIEF SUMMARY OF THE INVENTION

The general idea of this invention is to provide alternative power source to replace rechargeable batteries in electric toothbrushes, electric razor small tools like drills, engravers, cordless drills, grinders toy cars. Life cycle of the rechargeable batteries is limited, this novel approach provides an unlimited renewable resource as a power source, compressed air using a small air compressor a charging cradle, air flow control, air motor and gears to provide rotating motion for the appliance.

This invention details four examples of compress air driven system, dental brush, toy car, shaver cordless drill with detachable chuck using drill bits, grinder, engraver or screw driver attachments. Other ideal uses include but not limited to cordless sander or even small kitchen appliances where frequent cordless use is desired.

### BRIEF DESCRIPTION OF SEVERAL VIEWS OF THE DRAWING

FIG. 1 on sheet 1 shows a compress air driven toothbrush with cylindrical tank, pressure/airflow controller to control the rotation speed of the air motor and the detachable brush assembly.

FIG. 2 shows the worm gear driven brush plate located inside the top of the detachable brush assembly,

FIG. 3 and FIG. 4 shows the air motor from the top with the blades and mashing gears.

Sheet 2 of 5 FIG. 5 shows the side perspective view of the air motor.

FIG. 6 shows the compressed air driven toy car, tank, air flow controller, worm gear type driving transmission

FIG. 7. Sheet 3 of 5 shows the re-charger cradle, air hose from a small compressor, pressure controller with a gage and air valve location.

FIGS. 9 and 10 shows the cross section of the air flow/speed controller, short burst flow could be achieved by depressing knob (4), by rotating it steady airflow and reduced air pressure provides constant air motor speed. Sheet 4 of 5 shows a cross section of a “electric razor” with an air tank, air flow controller, air motor and a gear driven shaving head assembly with screen and rotating blades.

FIG. 12 is a momentary air switch used for blowing out the shaved off hair.

Sheet 5 of 5 FIG. 13 shows for illustration purposes a prior art detachable chuck, compressed air driven driving assembly as in FIG. 1.

Prior art attachments FIG. 14 grinder bit, FIG. 15 drill bit, FIG. 16 Screw driver bit, FIG. 17 engraver bit.

### DETAILED DESCRIPTION OF DRAWINGS

This new utility invention is novel way to provide rotating power by compressed air to a toothbrush, razor, toy cars small drills, engravers and other small appliances for short time cordless use.

Sheet 1 of 4 FIG. 1 shows a compressed air driven toothbrush, claimed as a new art.

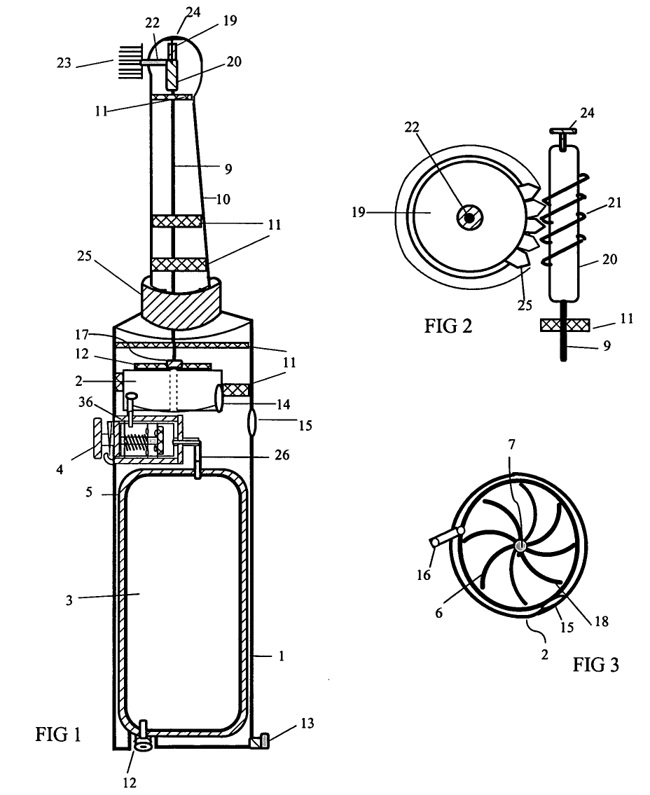

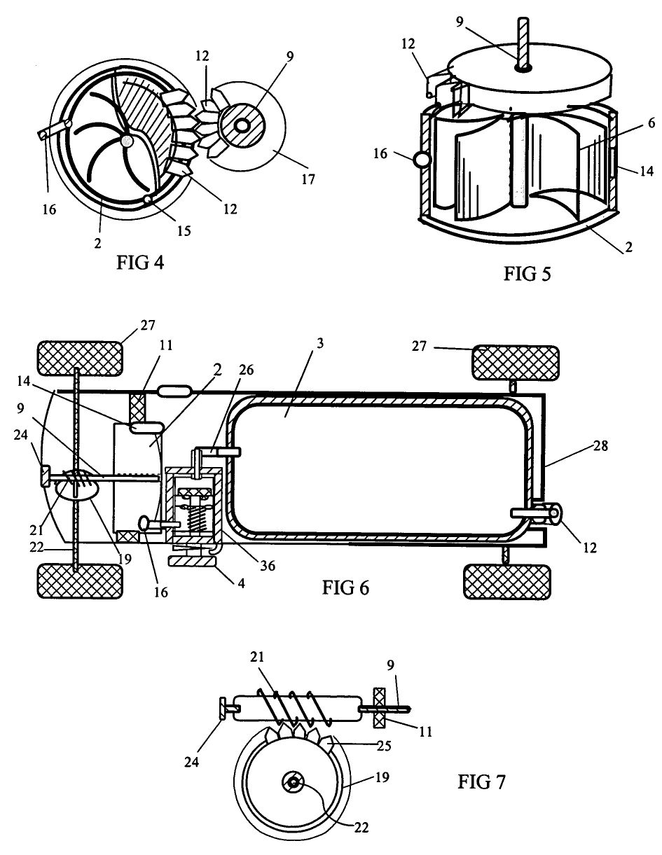

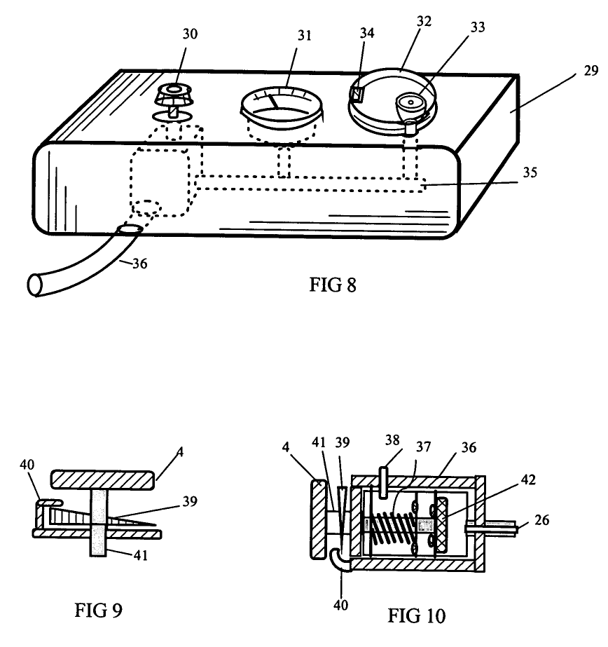

The body of the tooth brush handle (1) holds a cylindrical air tank (3) with and air intake valve (12). Compressed air flows out to the pressure controller valve (36) using flexible high pressure hose (26). Valve (36)—new art—also shown on sheet 3 of 4 FIG. 9 and 10 in closed position as valve contact (42) closes off the airflow with spring (37). When knob (4) is momentarily depressed air flows out at hose connector (38) to the air motor (2). Knob (4) is also rotateable, triangular shaped disk (39) is attached to the stem (41), as it is rotated it changes the air flow/air pressure, therefore the air motor speed. The partially rotated triagonal disk (39) is pressed against air gap back stop (40) to provide steady air flow/air speed. FIG. 3 shows the top view of basic air motor FIG. 4, 5. Air flows into air motor (2) at intake (16) rotates the blades (6) and air exits at (14). In the body of the toothbrush is an opening (15) to allow the air out flow. On the top of the air motor gears (12) drive the smaller driven gear (17) trough shaft (9), rotating shaft transfers the power to the worm gear (20) FIG. 2. Spacers (11) and (24) keep the shaft (9) in a steady position to rotate the brush gear plate (19) rotating the brush (23) by the shaft (22).

FIG. 8 on sheet 3 shows the recharging cradle (29). Many prior art compressors could be used, as compressed air is coupled trough high pressure hose (36) to pressure controller (30), gage (31) to hose adapter (33). Air re-charging for the tooth brush (1) is in the circular charging bay (32) where the bottom side tooth brush (1) at location (13) is shaped such a way as to be placed into the cradle under overhang (34) allowing the body of the tooth brush to be pivoted against the air valve (33) for easier air recharging. All components of the cradle (29) considered prior art items creating a new art as an “air charging cradle”.

FIG. 6 on sheet 2 of 4 shows a toy car (28) powered by compressed air to eliminate the use of alkaline or rechargeable battery.

Tank (3) is charged up by valve (12), pressured air is connected to air flow controller (36) via hose (26). Regulated air drives the air motor (2), air intake is (16), out flow (14). When knob (4) turns on the air flow, air motor (2) rotates the worm gear (21) on shaft (9). Spacers (11 and 24) keep the worm gear in stable position for proper gear mashing with gear (19) as worm gear (21) drive the axle (22) shaft gears (25) driving the wheels (27).

Sheet 4 of 4 FIG. 11 shows a general prior art angled shaver (43) with a new art driving system. Rotating air motor (2) rotates (gear (44) with shaft (49) shaver blades (47) against stationary screen (46). All driving components are the same as described before.

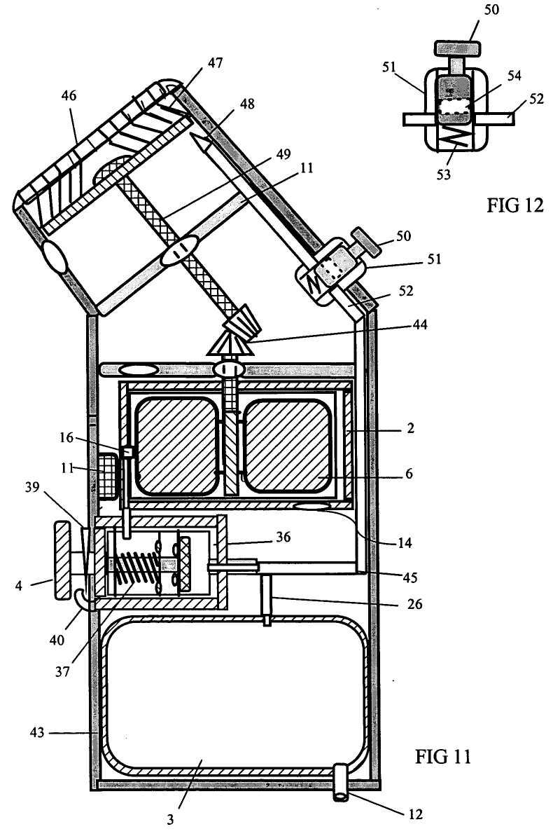

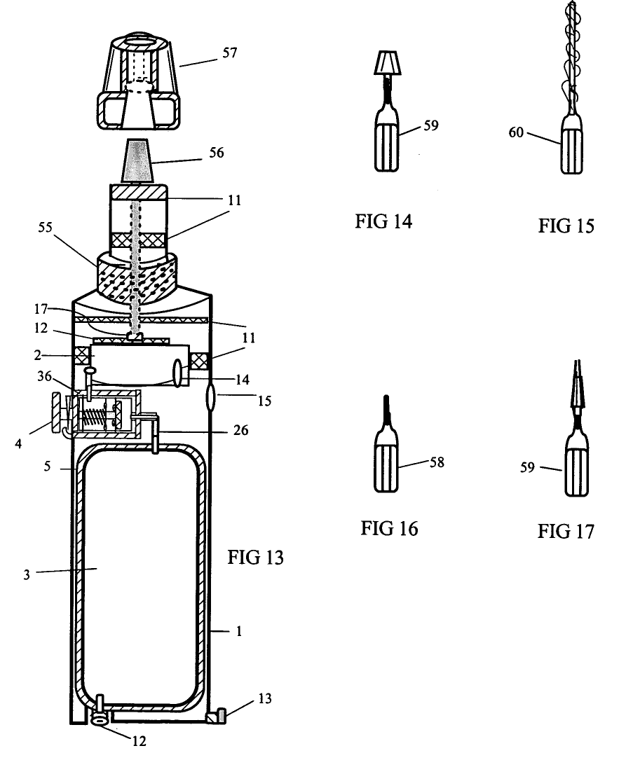

Additional new art is the FIG. 12 a momentary air flow switch (51) when depressed by knob (50), it allows the air to flow trough hose (45) and connecting tube (52) to jet tip (48) to blow away the shaved off hair for self cleaning.

Sheet 5 of 5 FIG. 13 shows the basic cordless compressed air driven air motor assembly as shown in FIG. 1 with a detachable chuck adapter (55). Chuck adapter terminates in a slightly cone shaped (56) shaft to allow the mating of many prior art type chucks (57). Adaptable bits are (but not limited to) FIG. 14 grinder bit (59), FIG. 15 drill bit (60), FIG. 16 screw driver bit (58), FIG. 17 engraver bit (17).

My invention resides not in any one of these features per se, but rather in the particular combination of all of them herein disclosed and claimed and it is distinguished from the prior art in this particular combination of all of its structures for the functions specified.

1. Compressed Air Pressure Driven Tooth Brush, Toy, Shaver, Drill, Screw Driver, Engraver, Sander comprising:
a small cylindrical rechargeable Compressed Air Pressure tank to store mobile energy to drive a Tooth Brush, Toy, Shaver, Cordless Drill, Screw Driver, Grinder, Sander, or a small cordless appliance replacing alkaline or reusable battery using air as a reusable energy source.

2. A dual function push and turn airflow controller to adjust airflow/speed for the small appliance for an air motor.

3. An air motor, using controlled, regulated air flow to generate rotational power to drive a shaft or a gear.

4. A compressed air charger cradle with pressure adjuster, pressure gage to allow tank refills;
a worm gear type gear driving a rotating gear assembly of he tooth brush or the toy car as mentioned in claim one.

5. Compressed air driven air motor with a detachable chuck to allow use of drill bits, grinder bits, engraver bits, screw driver attachments.
